(19) United States
(12) Patent Application Publication
(10) Pub. No.: US 2025/0238224 A1
(43) Pub. Date: Jul. 24, 2025

(54) TERMINAL DEVICE, CONTROL METHOD THEREFOR, AND NON-TRANSITORY COMPUTER-READABLE STORAGE MEDIUM CONTAINING COMPUTER-EXECUTABLE INSTRUCTIONS FOR TERMINAL DEVICE

(71) Applicant: BROTHER KOGYO KABUSHIKI KAISHA, Nagoya (JP)

(72) Inventor: Kazuaki OGAWA, Ichinomiya (JP)

(21) Appl. No.: 19/016,763

(22) Filed: Jan. 10, 2025

(30) Foreign Application Priority Data
Jan. 19, 2024 (JP) 2024-006470

(51) Int. Cl. G06F 8/65; G06F 9/445

(52) U.S. Cl. CPC G06F 8/65; G06F 9/44505

(57) ABSTRACT

A terminal device includes a controller configured to perform a series of processes related to a communication device. The controller is configured to execute a first process in the series of processes. The terminal device is restricted from communicating with the communication device in the first process. The controller is further configured to execute a second process that does not require the communication with the communication device during execution of the first process.

### REFERENCE TO RELATED APPLICATIONS

This application claims priority from Japanese Patent Application No. 2024-006470 filed on Jan. 19, 2024. The entire content of the priority application is incorporated herein by reference.

### BACKGROUND ART

The present disclosure relates to a terminal device, a control method of the terminal device, and a non-transitory computer-readable storage medium containing computer-executable instructions for the terminal device.

There has been known a print system including a print service providing device, a printer, and a distribution server. Typically, the print service providing device provides a print service to users. The printer performs printing in association with the print service providing device.

In this print system, there could arise a case where, when printer information is registered in the print service providing device, a firmware of the printer does not support a service provided by the print service providing device. In such a case, the distribution server distributes firmware that supports the print service provided by the print service providing device. The firmware distributed from the distributor server is installed in the printer.

### SUMMARY

In the print system as described above, it is generally necessary that, when the firmware is being installed in the printer, communication between the print service providing device and the printer is restricted, and the print service providing device needs to wait for completion of the installation of the firmware to register the printer information therein. Therefore, in such a case, a series of processes of the print system could be delayed.

According to an aspect of the present disclosure, a non-transitory computer-readable storage medium contains computer-executable instructions that are executable by a computer of a terminal device. The computer-executable instructions realizes an application program for performing a series of processes related to a communication device. The application program is configured to, when executed by the computer, cause the terminal device to execute a first process in the series of processes, the terminal device being restricted from communicating with the communication device in the first process, and a second process that does not require the communication with the communication device during execution of the first process.

A control method is for performing a series of processes related to a communication device. The control method comprises a first process in the series of processes, the terminal device being restricted from communicating with the communication device in the first process, and a second process that does not require the communication with the communication device during execution of the first process.

A terminal device comprises a controller configured to perform a series of processes related to a communication device. The controller is configured to execute a first process in the series of processes, the terminal device being restricted from communicating with the communication device in the first process, and a second process that does not require the communication with the communication device during execution of the first process.

### BRIEF DESCRIPTION OF DRAWINGS

FIG. 1 is a block diagram illustrating an electrical configuration of a print system according to an embodiment of the present disclosure.

FIG. 2 is a block diagram illustrating procedures performed by a user.

FIG. 3 is a flowchart illustrating a main process executed in a terminal device of the print system.

### DESCRIPTION

A print service providing system (hereinafter, simply referred to as a “system”) 1 will be describe with reference the accompanying drawings. The drawings referred to are merely examples for the purpose of illustrating technical features of the system 1 and are not intended to limit the configuration of the system 1.

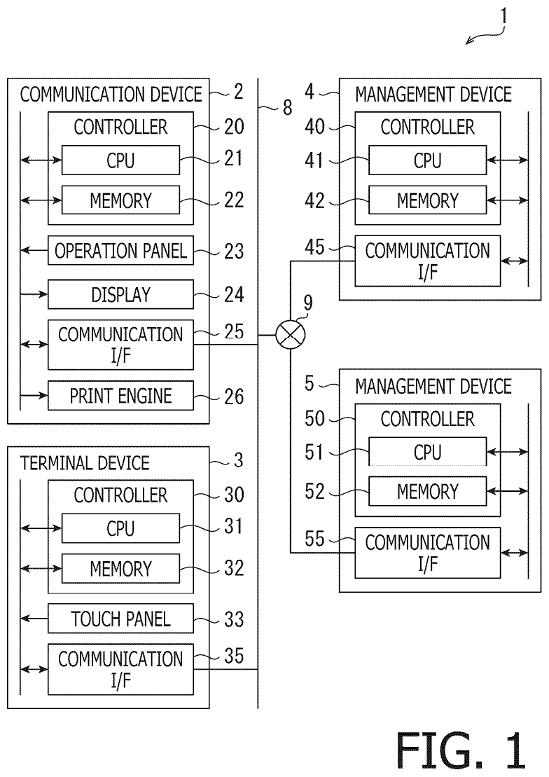

As shown in FIG. 1, the system 1 includes a communication device 2, a terminal device 3, and management devices 4 and 5. The communication device 2 in this embodiment is a printer having a communication function. The terminal device 3 is of a mobile device such as a mobile phone (e.g., a smartphone). The management devices 4 and 5 are servers configured to manage various data.

The communication device 2 and the terminal device 3 are connected to a LAN (Local Area Network) 8. The communication device 2 and the terminal device 3 can communicate with each other via the LAN 8. A connection method with the LAN 8 can be wired or wireless. The communication device 2, the terminal device 3, and the management devices 4 and 5 are connected to the Internet 9, and can communicate with each other via the LAN 8 and the Internet 9.

The communication device 2 include a controller 20, an operation panel 23, a display 24, a communication I/F (abbreviation of “interface”) 25 and a print engine 26.

The controller 20 includes a CPU 21 and a memory 22. The CPU 21 is configured to control overall operations of the communication device 2. The memory 22 includes a volatile memory and a non-volatile memory. The memory 22 stores device ID, a model name, firmware, a firmware version (hereinafter referred to as “FW version”), and time information. The device ID is information that identifies the communication device 2. The model name is a unique name given to each model of the communication device 2. The firmware is a program to be executed by the CPU 21. The FW version indicates a version number of the firmware stored in the memory 22. The time information indicates the usage time of the communication device 2. The CPU 21 constantly calculates a cumulative value of the usage time of the communication device 2, and stores the calculated value in the memory 22 as the time information.

The operation panel 23 is provided with multiple keys. The user can input various commands in the communication device 2 by the operating the keys of the operation panel 23. The display 24 is for displaying various pieces of information. The communication I/F 25 is a driver element to connect with the LAN 8 to perform communication. The print engine 26 is configured as an inkjet printing mechanism. The print engine 26 includes cartridges containing ink, and the print engine 26 perform printing using the ink contained in the cartridges.

To each cartridge, an IC chip storing a cartridge number is attached. The CPU 21 of the communication device 2 is configured to read the cartridge number from the IC chip of the cartridge attached to the print engine 26 and identify information on a type of the cartridge (hereinafter, referred to as “cartridge information”) of the cartridge to which the IC chip is attached. Alternatively, information corresponding to the type of the cartridge may be stored in the IC chip and the CPU 21 may identify the cartridge information by reading the information stored in the IC chip.

In the terminal device 3, an application to be used by the user is installed. The terminal device 3 includes a controller 30, a touchscreen panel 33 and a communication I/F 35.

The controller 30 includes a CPU 31 and a memory 32. The CPU 31 is configured to control overall operations of the terminal device 3. The memory 32 includes a volatile memory and a non-volatile memory. The memory 32 stores various programs and a program for performing various processes and applications. The touchscreen panel 33 has functions of a display and an operation panel. By operating the touchscreen panel 33, the user can input various commands in the communication device 2, the management devices 4 and 5. The communication I/F 35 is a driver element to connect with the LAN 8 to perform communication.

In the following description, the terms ‘process’ and ‘procedure’ are used in a general sense. These terms are roughly, but not strictly, used such that a process includes procedures. In one example, the user may perform registration for a service (hereinafter, referred to as a “service enrollment process”) by operating the terminal device 3. The term “service” may include, for example, a flat-rate printing service, an automatic ordering service, and a notification service.

The flat-rate printing service and the automatic ordering service are related to a so-called “subscription service.” The flat-rate printing service is a service that provides a preset number of surfaces (e.g., 200 surfaces) for a fixed fee (i.e., a flat rate). With the flat-rate printing service, if the number of printed faces from the communication device 2 exceeds the number of printed faces specified in the contract (e.g., 1000 printed faces) during a predetermined period (e.g., one month), the user is charged a combined amount that includes the additional charge for the number of printed faces exceeding the contracted amount and the fixed fee.

The automatic ordering service is a service in which, when the remaining amount of ink in the cartridge of the communication device 2 decreases below a predetermined amount, the CPU 31 automatically orders a new cartridge, which is then delivered to the user.

The notification service is a service that notifies information about the communication device 2, and the like, to the terminal device 3 from the management devices 4 and/or 5.

The management device 4 is installed on the Internet 9 by the vendor of the communication device 2. The management device 4 is configured to manage detailed information (hereinafter also referred to as “device identification information”) about the communication device 2. The device identification information is the information for each device ID, such as the model names, the FW versions, the time information, and the cartridge information.

The management device 4 includes a controller 40 and a communication I/F 45. The controller 40 includes a CPU 41 and a memory 42. The CPU 41 is configured to control overall operations of the management device 4. The memory 42 includes a volatile memory and a non-volatile memory. The memory 42 stores programs executed by the CPU 41 and device identification information. The communication I/F 45 is a driver element to connect with the Internet 9 to perform communication.

The management device 5 is installed on the Internet 9 by the vendor of the communication device 2. The management device is configured to manage various pieces of information necessary to provide services to users (hereinafter, also referred to as “user information”). The user information includes personal information such as email addresses, passwords, and payment information.

The management device 5 includes a controller 50 and a communication I/F 55. The controller 50 includes a CPU 51 and a memory 52. The CPU 51 is configured to control overall operations of the management device 5. The memory 52 includes a volatile memory and a non-volatile memory. The memory 52 stores programs executed by the CPU 51. The communication I/F 55 is a driver element to connect with the Internet 9 to perform communication.

In order to receive the services of the above system 1, the user needs to register the “device identification information” with the management device 4 and register the “user information” with the management device 5.

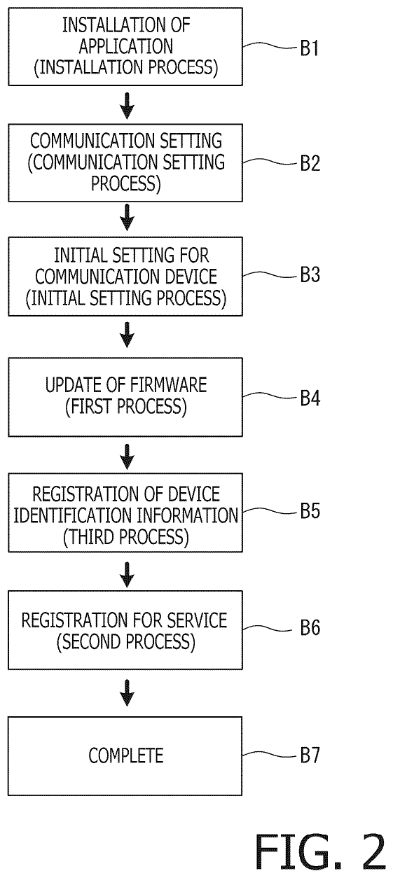

Referring to FIG. 2, process to be performed by a user who has purchased the communication device 2 in order to receive the above-mentioned service are explained. As an example, the user performs the processes of blocks B1 to B7 shown in FIG. 2. First, the user operates the terminal device 3 to install the application (B1). The process performed by the terminal device 3 when the user performs the process in block B1 is referred to as an “installation process.”

Next, the user configures network settings for the communication device 2 (B2). The process performed by the terminal device 3 when the process in block B2 is performed by the user is referred to as a “communication setting process.” The communication setting process enables the communication device 2 to communicate with the terminal device 3, management devices 4 and 5.

Then, the user performs initial settings for the communication device 2 (B3). A process performed by the terminal device 3 when the user performs the process in block B3 is referred to as an “initial setting process.” The initial setting procedure is the process of setting the communication device 2 to a usable state. In the initial setting procedure, for example, the terminal device 3 prompts the user to attach the ink cartridge to the communication device 2. The user then refills the ink in the communication device 2. In the initial setting procedure, the terminal device 3 receives settings such as image quality adjustment at the time of printing from the user.

Next, the user updates the firmware of the communication device 2 to the latest version (B4). In the present embodiment, for example, the user instructs the terminal device 3 to update the firmware, but updating may be done automatically. The firmware may be downloaded directly from the management device 4 to the communication device 2, or the firmware may be downloaded from the management device 4 to the terminal device 3 and then to the communication device 2. The process performed by the terminal device 3 when the user performs the process in block B4 is referred to as a “first process.” It should be noted that, according to the present embodiment, during the firmware update, the communication device 2 will become unable to communicate with any of the terminal device 3, the management device 4, or the management device 5. That is, the first process is a process in which communication with the communication device 2 is restricted.

In one example, when the firmware update for communication device 2 has been completed, the user registers the device identification information with the management device 4 (B5). Therefore, based on the device identification information, the management device 4 can obtain the FW version of the updated firmware. The process, which is performed by the terminal device 3 when the user performs the process in block B5, is referred to as a “third process.” In the third process, for one example, the terminal device 3 instructs the communication device 2 to register the device identification information with the management device 4. It should be noted that the third process can only be performed after the first process, i.e. after the firmware update. Further, the third process is a process that requires communication with the communication device 2.

In block B6, the user performs a registration process for the service. The process performed by the terminal device 3 when the user performs the process in block B6 is referred to as a “second process.” The second process is a process that does not require communication with the communication device 2. In one example, the second process includes a service enrollment procedure. The service enrollment procedure is for a user of the communication device 2 to enroll in the service.

The service enrollment procedure includes an input procedure, a second registration process, and a third registration procedure. The input procedure is a procedure to have the user enter user information. In one example, the terminal device 3 displays a format for the user to enter the user information. The second registration procedure is a procedure of registering the user information entered by the user from the terminal device 3 to the management device 5. The third registration process is a process of registering on/off settings for notification functions, and the like, from the management device 5. This information above is registered in a database stored in the memory 52 of the management device 5.

Upon completion of the process in block B6, all processes in order to receive the service are completed (B7). After this, it becomes possible for the user to receive the service from the vendor.

The processes for receiving the service described above are the usual ones performed by the user. The processes performed by the terminal device 3 in blocks B1 to B7 may also be referred to collectively as “a series of processes.” During the firmware update in block B4, communication will be unavailable. Therefore, in order to perform the processes in block B5 onwards, it is necessary to wait for the completion of the firmware update. However, by performing a main process described below, the terminal device 3 can perform a series of processes without delay.

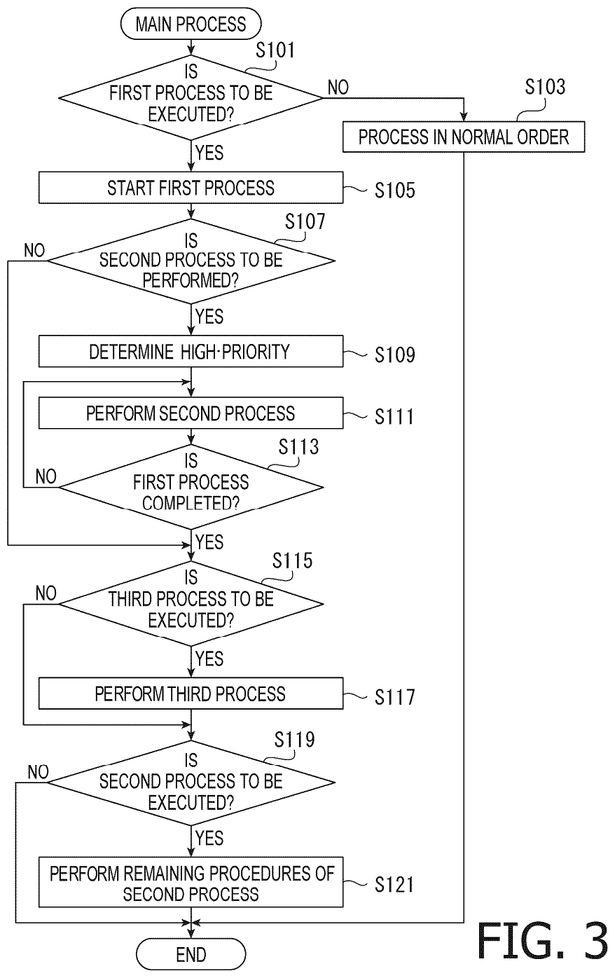

The main process shown in FIG. 3 is a process that is started when a user who has purchased the communication device 2 installs the application on the terminal device 3 (see block B1 in FIG. 2). In such an example, the CPU 31 retrieves the application program from the memory 32 and performs the main process.

When the main process is started, the CPU 31 determines whether or not to perform the first process (S101). If it is determined that there is no need to perform the first process (S101: NO), that is, if it is determined that the FW version is the latest, the CPU 31 performs the series of processes in the normal order (S103). With the exception of the installation of the application (B1), the series of processes is performed in the order shown in FIG. 2. The CPU 31 waits for the series of processes to be completed and then terminates the main process.

If it is determined that the first process needs to be performed (S101: YES), the CPU 31 starts the first process (S105). In one example, the communication device 2 downloads the firmware from the management device 4 or the terminal device 3 and performs the firmware update procedure. In such a case, the communication device 2 becomes unable to communicate with any of the management devices 4, 5, or the terminal device 3.

In S107, the CPU 31 determines whether or not to perform the second process. If it is determined that there is no need to perform the second process (S107: NO), the CPU 31 proceeds to S115. It is noted that cases where there is no need to perform the second process include cases where the user is not eligible for the service or where the user information has already been registered.

On the other hand, if it is determined that the second process needs to be performed (S107: YES), for example, if the user enrollment procedure has not yet been performed, the CPU 31 determines a high-priority procedure from among procedures included in the second process (S109). The CPU 31 determines that the procedure that requires the longest time to complete among the procedures of the second process is the procedure with the highest priority. For example, in the service enrollment procedure, the user needs to enter the personal information into the terminal device 3. In such a case, since the time taken for the service enrollment procedure is affected by the user's work efficiency, it takes time to complete the service enrollment procedure. Therefore, for example, the CPU 31 determines that an input procedure included in the service enrollment procedure is the high-priority procedure.

In S111, the CPU 31 firstly executes a procedure with the higher priority among procedures of the second processes. In this way, the second process is executed in order from the procedures with the higher priority. In other words, the CPU 31 performs the second process while performing the first process.

In S113, the CPU 31 determines whether the first process has been completed. In this case, for example, the CPU 31 checks whether or not there is a notification from the communication device 2 indicating that the firmware update has been completed. If it is determined that the first process has not been completed (S113: NO), the CPU 31 returns to S111 and continues the second process. The CPU 31 repeatedly executes the determination of whether the first process has been completed or not at a particular cycle.

If the CPU 31 determines that the first process is completed (S113: YES), the CPU 31 proceeds to S115. It should be noted that, when transferring from S113 to S115, it is also possible that the second process will be interrupted and the third process will be performed. Further, when transferring from S113 to S115, there may be a case where the remaining procedures of the second process have not yet been completed.

In S115, the CPU 31 determines whether or not the third process needs to be performed. If it is determined that the third process does not need to be performed (S115: NO), the CPU 31 proceeds to S119. If determining that the third process needs to be performed (S115: YES), the CPU 31 performs the third process (S117). In such a case, in one example, the CPU 31 performs the first registration procedure and registers the device identification information with the management device 4. Even if the second process has not been completed, the CPU 31 prioritizes performing the third process over the second process. The CPU 31 can promptly register the device identification information to the management device 4. After the third process has been completed, the CPU 31 proceeds to S119.

In S119, the CPU 31 determines whether or not to perform the second process. In one example, if the second process is interrupted by the transition from S113 to S115 (S119: YES), the CPU 31 restarts the second process (S121). If there are any procedures in the second process that have not yet been performed (S119: YES), the CPU 31 performs the remaining procedures in the second process (S121). Then, the CPU 31 terminates the main process.

On the other hand, if all the procedures in the second process have been completed (S119: NO), the CPU 31 terminates the main process. In this way, the series of processes is completed, and the user can receive the service related to the communication device 2.

As described above, the CPU 31 performs the first process, which is restricted in communication with the communication device 2, in the series of processes. During the performing of the first process, the CPU 31 performs the second process, which does not require communication with the communication device 2.

According to the above system 1, even when performing the first process that restricts communication with the communication device 2, the series of processes can be executed quickly.

The first process includes an update procedure. The update procedure is for updating the firmware of the communication device 2. Even if the communication between the communication device 2 and the terminal device 3 is restricted due to the firmware update, the system 1 can execute the series of processes promptly.

The second process includes the service enrollment procedure. The service enrollment procedure includes a service enrollment procedure that allows the user of the communication device 2 to enroll in the service. The above system 1 can execute the series of processes quickly by having the user's service enrollment procedure executed while the first process is being executed.

The service enrollment procedure includes an input procedure. The input procedure is a procedure that allows the user of communication device 2 to enter the user information. By allowing the user to enter the user information while the system 1 is executing the first process, the system 1 can execute the series of processes quickly.

The service enrollment procedure includes a second registration procedure. The second registration procedure is an operation that registers the user information input in the input procedure from the terminal device 3 to the management device 5. By having the user information registered in the management device 5 while the first process is being executed, the system 1 can execute the series of processes quickly.

In S113, the CPU 31 determines whether the first process has been completed. If determining that the first process has been completed (S113: YES), the CPU 31 executes the third process, which requires communication with the communication device 2 (S115). In this way, the system 1 can execute the third process after completion of the first process.

The CPU 31 is configured to determine whether the first process has been completed at a particular cycle. That is, the system 1 can check the completion of the first process at a particular cycle. Therefore, the system 1 can execute the third process immediately after the completion of the first process.

The CPU 31 is configured to execute high-priority procedures of the second process first. The system 1 can execute high-priority procedures of the second process first even while executing the first process.

The CPU 31 is configured to determine that a procedure among procedures included in the second process and requires a long time to complete is the procedure with a high priority. The CPU 31 executes the procedure determined to have the high priority first. Accordingly, the system 1 can complete procedure among the procedures included in the second process and requires a long time to complete first.

In the above description, the CPU 31 may be an example of a “computer” according to aspects of the present disclosure. The process of S105 executed by the CPU 31 may be an example of a “first execution engine” according to aspects of the present disclosure. The process of S111 executed by the CPU 31 may be an example of a “second execution engine” according to aspects of the present disclosure. The process of S113 executed by the CPU 31 may be an example of a “determination engine” according to aspects of the present disclosure. The process of S117 executed by CPU 31 is an example of a “third execution engine” according to aspects of the present disclosure. The process of S109 executed by CPU 31 is an example of a “decision engine” according to aspects of the present disclosure.

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of aspects of the present disclosure, and not limiting the same. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations according to aspect of the present disclosure are provided below.

The communication device 2 according to the embodiment is an inkjet printer, but the communication device 2 is not necessarily limited to the inkjet printer, but may be a thermal printer or any other printers. Further, the communication device 2 may be a multifunctional device equipped with a scanning function, a fax function, and the like, in addition to the printing function. Furthermore, the communication device 2 may be anything that can be linked with the terminal device 3. The communication device 2 can be anything that has a communication function, such as a gadget of an individual user, such as a car, home appliance, or headphones. Further, the communication device 2 can be an industrial device, such as a machine tool. In other words, the communication device 2 can be any device on which the first process is executed.

In the above embodiment, the terminal device 3 is a smartphone, but the terminal device 3 is not necessarily limited to the smartphone. That is, the terminal device 3 may be a tablet PC, PC, PDA, or other device. In the above embodiment, different information is managed by the management devices 4 and 5, but it is also possible to manage the information by either the management device 4, the management device 5, or more management devices. The locations of the management devices 4 and 5 are not necessarily limited to Japan, but may be located in foreign countries. The information managed by the management devices 4 and 5 may be managed in a decentralized manner. The owners of the management devices 4 and 5 are not necessarily limited to the vendors of the communication device 2.

The process shown in FIG. 2 is performed in the order of blocks B1 to B7, but the order may be changed as long as it does not interfere with the operation. Further, processes other than blocks B1 to B7 may be added before, after, or in between the blocks B1 to B7. For example, an additional process of unpacking the communication device 2 may be performed before or after the application installation process (B1). After purchasing the communication device 2, the user unpacks the communication device 2 that has been packaged. When the process of block B1 is performed by the user, the process performed by the terminal device 3 is referred to as the “unpacking process” The unpacking process could be, for example, a process in which the terminal device 3 notifies the user of information such as “Have you unpacked the product?” in text or audio form. Not all of the processes in blocks B1 to B7 in FIG. 2 are necessary as a series of processes. Some of the blocks may be omitted within the scope of being able to execute the series of processes promptly.

In the above embodiment, the first process is an update procedure, but the first process is not necessarily limited to the update process. For example, the first process may include a first registration procedure. In other words, the first registration procedure, which is the third process after the firmware update, may be treated as the first process. If the first registration procedure is performed, the communication speed between the communication device 2 and the terminal device 3 may be restricted. The CPU 31 may execute the second process while the communication speed is being reduced, that is, during the first registration procedure is being performed. In this way, the system 1 can execute the series of processes quickly even when the communication between the communication device 2 and the terminal device 3 is restricted due to communication between the communication device 2 and the management device 4.

Further, the first process may include a communication setting procedure that configures the communication settings of the communication device 2. When performing the communication setting procedure, the communication speed between the communication device 2 and the terminal device 3 may be restricted. The CPU 31 may execute the second process during the execution of the communication setting procedure, i.e., while the communication speed is restricted. Therefore, the system 1 can execute the series of processes promptly, even if communication is restricted during the communication setting of the communication device 2.

The first process may also include an initial setting procedure. For example, while the user is performing the initial setting, the second process, which does not require the user's operation, may be executed. In such a case, the system 1 can promptly execute the series of processes even when the initial setting procedure being performed. Since the communication device 2 is a printer in the present embodiment, the system 1 can quickly execute the series of processes even when performing the initial setting procedure of the printer, such as ink replenishment and image quality adjustment.

In the above embodiment, the high-priority process among the second processes is determined, but the configuration is not necessarily limited to such an implementation. In one example, the priority may be determined in advance. Information on the priority may be stored as a table. The CPU 31 may refer to the table and execute the second process with the highest priority. Alternatively, the priority may be determined based on factors other than the time required for the process.

Instead of the CPU 31, a processor such as an ASIC or FPGA (Field Programmable Gate Array) may be used. Each main process may be distributed and processed by multiple processors. The communication device 2 may be equipped with other non-transitory storage medium, such as an HDD, for example. The non-transitory storage medium can be any storage medium that can retain information regardless of the period of time for which the information is stored. The transitory storage medium (e.g., a signal being transmitted) does not need to be included in the non-transitory storage medium.

Various programs may be downloaded from a server (e.g., management devices 4 or 5) connected to a network (not shown in the figures) and stored in a memory such as an HDD. In this case, the various programs may be stored in the non-transitory storage medium such as an HDD provided to the server.

What is claimed is:

1. A non-transitory computer-readable storage medium containing computer-executable instructions that are executable by a computer of a terminal device, the computer-executable instructions realizing an application program for performing a series of processes related to a communication device, the application program being configured to, when executed by the computer, cause the terminal device to execute:
a first process in the series of processes, the terminal device being restricted from communicating with the communication device in the first process; and
a second process that does not require the communication with the communication device during execution of the first process.

2. The non-transitory computer-readable storage medium according to claim 1,
wherein the first process includes an update procedure of updating firmware of the communication device.

3. The non-transitory computer-readable storage medium according to claim 1,
wherein the first process includes a first registration procedure of registering device identification information of the communication device from the communication device to a management device.

4. The non-transitory computer-readable storage medium according to claim 1,
wherein the first process includes a communication setting procedure of performing communication settings for the communication device.

5. The non-transitory computer-readable storage medium according to claim 1,
wherein the first process includes an initial setting procedure of setting the communication device in a usable state.

6. The non-transitory computer-readable storage medium according to claim 1,
wherein the communication device includes a printer.

7. The non-transitory computer-readable storage medium according to claim 1,
wherein the second process includes a service enrollment procedure allowing a user of the communication device to enroll in the service.

8. The non-transitory computer-readable storage medium according to claim 7,
wherein the service enrollment procedure includes an input procedure to have the user of the communication device enter user information of the user.

9. The non-transitory computer-readable storage medium according to claim 8,
wherein the service enrollment procedure includes a second registration procedure of registering the user information of the user from the terminal device to a management device.

10. The non-transitory computer-readable storage medium according to claim 1,
wherein the application program is further configured to, when executed by the computer, cause the terminal device to execute:
determining whether the first process has been completed; and
a third process that requires communication with the communication device in response to determining that the first process has been completed.

11. The non-transitory computer-readable storage medium according to claim 10,
wherein the application program is configured to, when executed by the computer, cause the terminal device to repeatedly execute determining whether the first process has been completed at a particular cycle.

12. The non-transitory computer-readable storage medium according to claim 10,
wherein the application program is configured to, when executed by the computer, cause the terminal device to firstly execute a procedure with a high priority among procedures of the second process.

13. The non-transitory computer-readable storage medium according to claim 12,
wherein the application program is configured to, when executed by the computer, cause the terminal device to:
determine that a procedure that requires a longer time to complete among procedures of the second process is the procedure with the high priority; and
firstly execute the determined procedure with the high priority.

14. A control method for performing a series of processes related to a communication device,
wherein the control method comprises:
a first process in the series of processes, the terminal device being restricted from communicating with the communication device in the first process; and
a second process that does not require the communication with the communication device during execution of the first process.

15. A terminal device comprising a controller configured to perform a series of processes related to a communication device,
wherein the controller is configured to execute:
a first process in the series of processes, the terminal device being restricted from communicating with the communication device in the first process; and
a second process that does not require the communication with the communication device during execution of the first process.
